(19) United States
(12) Patent Application Publication
(10) Pub. No.: US 2003/0114169 A1
(43) Pub. Date: Jun. 19, 2003

(54) Method and system for detecting the position of mobile station

(75) Inventors: Takeo Okamura, Yokohama (JP); Kei Fujiwara, Fujisawa (JP); Kenji Yanagi, Fujisawa (JP); Taiji Nakamura, Yokohama (JP); Takeshi Kawashima, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/093,642

(22) Filed: Mar. 7, 2002

(30) Foreign Application Priority Data
Dec. 14, 2001 (JP) 2001-380962

(51) Int. Cl. H04Q 7/20

(52) U.S. Cl. 455/456; 455/457

(57) ABSTRACT

In a mobile communication system including a plurality of base stations 10 and an MS position administrating station 30 connected to each of the base stations via a communication network, at least one of the base stations detects an arrival angle of a position detection signal from a mobile station and an average received power or propagation distance, and transmits the detected values as position detection parameters to the MS position administrating station, and the MS position administrating station detects the position of the mobile station on the basis of the position detection parameters and map information of an area including the base station.

### BACKGROUND OF THE INVENTION

(1) Field of the Invention

The present invention relates to a method and system for detecting the position of a mobile station and, more particularly, to a method and system for detecting the position of a mobile station, which detects the position of a radio source by analyzing a received radio wave in a base station for mobile communication having an adaptive array antenna.

(2) Description of the Related Art

A mobile communication system offers various position information providing services to terminal station users. Particularly, since a PHS in which a pico cell is formed for each of base stations densely arranged can realize relatively simple position information providing service of expressing the position of a mobile station on a cell unit basis, many proposals are made. For example, Japanese Unexamined Patent Publication No. 9-68566 discloses a method for detecting the position of a mobile station, in which the position of the mobile station is represented by the position of a base station in a communication coverage.

The position detecting method in which the position of a terminal station is represented by the position of a base station has a problem in detection accuracy because it is implemented on the premise of a detection error in cell size. There is a tendency to increase the power of an output wave of a base station in the PHS to thereby enlarge each of the cells. In this case, according to the conventional position detecting method, a detection error becomes too large, so that a problem such that the method is impractical arises.

### SUMMARY OF THE INVENTION

An object of the invention is to provide a method and system for detecting the position of a mobile station, capable of further localizing the position of the station within a cell of a radio base station.

Another object of the invention is to provide a method and system for detecting the position of a mobile station, capable of detecting the position of the mobile station by using the position of a base station as a reference even when the station is in a blind location over a building.

In order to achieve the objects, the invention provides a mobile communication system including a plurality of base stations and an MS position administrating station connected to each of the base stations via a communication network, in which at least one of the base stations has means for detecting an arrival angle of a position detection signal from a mobile station and an average received power or propagation distance of the position detection signal, and transmitting the detected values as position detection parameters to the MS position administrating station, and the MS position administrating station has means for detecting the position of the mobile station on the basis of the position detection parameters received from the base station and map information of an area including the base station.

A base station for mobile communication according to the invention comprises: a plurality of antenna elements; a plurality of weight adjusting units corresponding to the antenna elements; and an adaptive processor for controlling a weight value to be set in each of the weight adjusting units, and the adaptive processor has means for detecting an arrival angle of a position detection signal transmitted from a mobile station and an average received power or propagation distance of the position detection signal, and outputting the detected values as position detection parameters.

In the method of detecting the position of a mobile station according to the invention, a base station having the adaptive array antenna constructed by a plurality of antenna elements detects position detection parameters including the arrival angle of the position detection signal received from a mobile station and the average received power or propagation distance of the position detection signal, and the position of the mobile station is calculated by the base station or any of stations constructing the mobile communication system, on the basis of the position detection parameters and the map information of an area including the base station.

More specifically, the detection of the position detection parameters includes, for example, a first step of detecting the position detection parameter by a first adaptive algorithm for optimizing weight to be given to a received signal from each of the antenna elements with respect to the position detection signal, a second step of measuring an average received power by a second adaptive algorithm for optimizing weight to be given to a received signal from each of the antenna elements with respect to a received signal from a specific arrival angle direction detected by the first step, and a third step of verifying the position detection parameter by comparing the average received power measured in the first step with the average received power measured in the second step.

According to an embodiment of the invention, when it is determined that the position detection parameter is inappropriate in the third step, for example, measurement of the average received power is repeated while changing an arrival angle to be optimized in accordance with the second adaptive algorithm, an average received power and an arrival angle as peak values are detected, and the detected values are set as new position detection parameters.

According to an embodiment of the invention, in detection of the position detection parameters, the arrival angle of an interference wave is detected in a state where weight to be given to a received signal is optimized by the first adaptive algorithm, and in the third step, the new position detection parameters are detected by eliminating the arrival angle of the interface wave.

A feature of the invention resides in that, in calculation of the position of a mobile station, a straight distance from the base station to the mobile station is calculated on the basis of an average received power indicated in the position detection parameters and a formula expressing a preliminarily given propagation distance characteristic, the presence or absence of an obstacle between the base station and the mobile station is determined on the basis of map information of an area including the base station and, when it is determined that there is no obstacle, the position of the mobile station is specified on the map on the basis of the position of the base station, the arrival direction indicated in the position detection parameters, and the straight distance.

When it is determined that there is an obstacle between the base station and the mobile station, for example, reflection points and a propagation path of the position detection signal are specified in accordance with the map information, the propagation distance is calculated by using a preliminarily modeled reflection coefficient of each of reflection points, and the position of the mobile station is specified on the map.

Another feature of the invention resides in that, when the arrival angle and propagation distance of the radio wave received from a mobile station are given as the position detection parameters, the presence or absence of an obstacle between the base station and the mobile station is determined on the basis of map information of the area including the base station. When it is determined that there is no obstacle between the base station and the mobile station, the position of the mobile station on the map is specified on the basis of the position of the base station and the position detection parameters. When it is determined that there is an obstacle between the base station and the mobile station, for example, reflection points and a propagation path of the position detection signal are specified in accordance with the map information, and the position of the mobile station on the propagation path is specified.

The other features of the invention will become apparent from the following description of embodiments referring the accompanied drawings.

### BRIEF DESCRIPTION OF THE DRAWINGS

FIG. 1 is a diagram showing a general configuration of a mobile communication system having a position detecting function according to the invention.

FIG. 2 is a block diagram showing the configuration of an MS position administrating station 30 in FIG. 1.

FIG. 3 is a sequence diagram showing the procedure of position detection in a position detecting system according to the invention.

FIG. 4 is a block diagram showing the configuration of main components of a base station 10 in FIG. 1.

FIG. 5 is a diagram showing the relation between the arrangement of an adaptive array antenna and a received signal.

FIG. 6 is a diagram for explaining input signals processed by an adaptive processor 14 illustrated in FIG. 4.

FIG. 7 is a flowchart of a position parameter detecting routine 200 executed by the adaptive processor 14.

FIG. 8 is a diagram showing an example of the result of position detection in the case where a mobile station is visible from a base station.

FIG. 9 is a diagram showing an example of the result of position detection in the case where a mobile station is blind from a base station.

FIG. 10 is a diagram for explaining the structure of map data stored in a map data file of the MS position administrating station 30.

FIG. 11 is a diagram showing the configuration of a conversion table 36 of the MS position administrating station 30.

FIG. 12 is a flowchart of a position detecting routine 300 executed by the MS position administrating station 30.

FIG. 13 is a sequence diagram showing another example of the position detecting procedure in the position detecting system of the invention.

FIG. 14 is a diagram for explaining an example of a method of measuring propagation distance of a radio wave (position detection signal) in a base station.

FIG. 15 is a flowchart of a position detecting routine 300S executed in the case where position parameters include the propagation distance of a radio wave.

### DESCRIPTION OF THE PREFERRED EMBODIMENTS

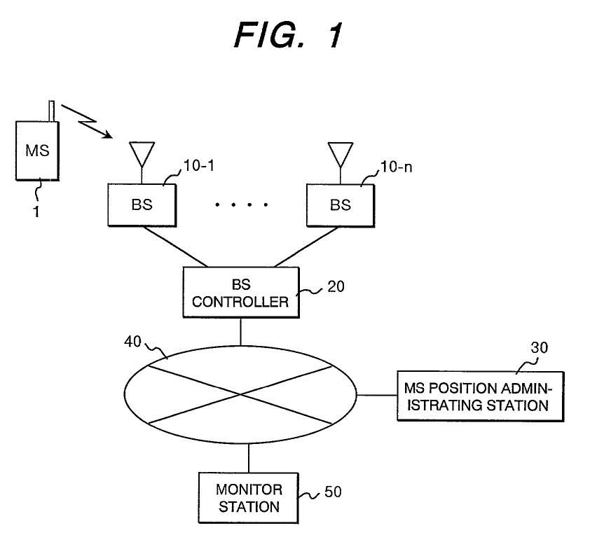

FIG. 1 shows a general configuration of a mobile communication system having a position detecting function according to the invention.

The mobile communication system of the invention has a plurality of base stations (BS) 10 (10-1 to 10-n) connected to a communication network 40 via a BS controller 20, and an MS position administrating station 30 and a monitor station 50 which are connected to the communication network 40. The monitor station 50 is not an essential component.

Each of the base stations 10 has an adaptive array antenna as will be described hereinlater. When a position detection request is generated from an arbitrary mobile station (MS) 1, a base station, for example, 10-1, which receives the position detection request sends a notification to the MS position administrating station 30. The base station 10-1 collects position parameters necessary to calculate the position of the mobile station in response to an instruction from the MS position administrating station and notifies the MS position administrating station 30 of the position parameters.

The MS position administrating station 30 is installed to manage the present position of each of the mobile stations in the mobile communication system. The MS position administrating station 30 memorizes the relation between each base station and mobile stations locating in the coverage of the base station.

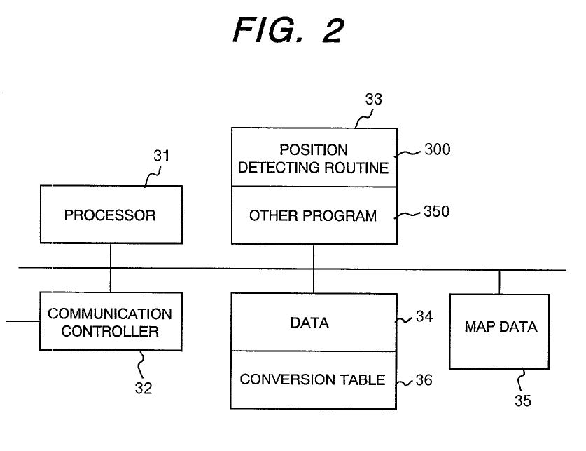

The MS position administrating station 30 includes, as shown in FIG. 2, a processor 31, a communication controller 32 for establishing connection with the communication network 40, a program memory 33 in which various programs to be executed by the processor 31 are stored, a data memory 34 for managing the position of each of the mobile stations, a map data file 35, and a conversion table 36. In the program memory 33, a position detecting routine 300 which will be described hereinlater and other programs 350 for realizing various functions required by the MS position administrating station 30 are stored.

The MS position administrating station 30 detects the position of a mobile station on the basis of the position parameters received from the base station 10-1, map information corresponding to the base station 10-1 read out from the map data file 35, and modeled structure information, and notifies the mobile station 1 of the position via the base station 10-1. The conversion table indicates the corresponding relation of the identification number of each base station 10 and the map area in which the base station is located. By referring to the conversion table, map information of the specific area necessary to detect the position of the mobile station is read out from the map data file 35.

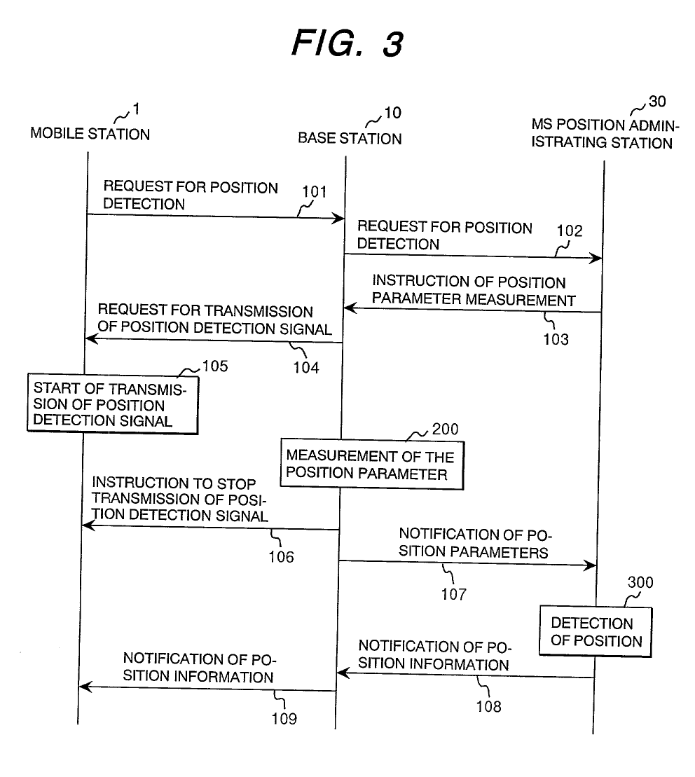

FIG. 3 is a sequence diagram showing the procedure of position detection in the position detecting system.

When the mobile station 1 issues a position detection request (step 101), the base station 10, which receives the position detection request, notifies the MS position administrating station 30 of the request (step 102). On receipt of the position detection request, the MS position administrating station 30 instructs the base station 10 to measure the position parameters (step 103). The base station 10 which receives the position parameter measurement instruction requests the mobile station 1 to transmit a position detection signal (step 104) and starts measurement of the position parameters (200).

On receipt of the transmission request of the position detection signal, the mobile station 1 starts transmission of a signal having a predetermined pattern as a position detection signal (step 105). The base station 10 measures the arrival angle and average received power of the position detection signal (target radio wave) transmitted from the mobile station 1. After completion of the measurement of the arrival angle of the target radio wave and the average received power as position parameters, the base station 10 instructs the mobile station 1 to stop the transmission of the position detection signal (step 106) and notifies the MS position administrating station 30 of the position parameters (step 107).

When the instruction of stopping the transmission of the position detection signal is received, the mobile station 1 stops the transmission of the position detection signal and waits for a notification of a position detection result. On receipt of the position parameters from the base station 10, the MS position administrating station 30 starts the detection processing of the position (300).

In the detection processing of the position (300) on the basis of the position parameters and the map information and structure information in the communication coverage of the base station 10, the position of the mobile station 1 is calculated. After completion of the position detection, position information is transmitted from the MS position administrating station 30 to the base station 10 (step 108), and the base station 10 notifies the mobile station 1 of the position information (step 109). The position of the mobile station is notified, for example, in the form of map information indicating the present position or the form of address indication.

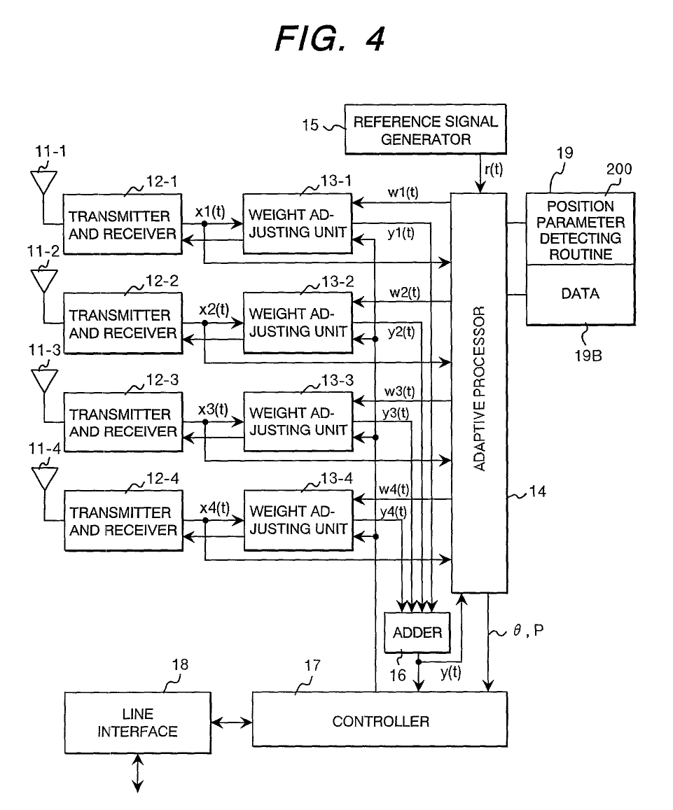

FIG. 4 shows the configuration of main components of the base station 10.

The base station 10 includes four antenna elements 11 (11-1 to 11-4), transmitter and receivers 12-i (i=1 to 4) connected to the antenna elements 11, weight adjusting units 13-i (i=1 to 4) connected to the transmitter and receivers, an adaptive processor 14 for optimizing weight wi (i=1 to 4) of the weight adjusting units 13-i, a reference signal generator 15 for generating a reference signal r(t) to be given to the adaptive processor 14, an adder 16 for adding output signals yi (i=1 to 4) of the weight adjusting units 13-1 to 13-4, a controller 17 connected to the adder 16 and the weight adjusting units 13-i, and a line interface 18 for connecting the controller 17 to the communication network 40. A transmission signal from the communication network side to a mobile station is supplied from the controller 17 to the transmitter and receivers 12-i (i=1 to 4) via the weight adjusting units 13-i.

The adaptive processor 14 optimizes the weight wi (i=1 to 4) of the weight adjusting units 13-i in accordance with received signals xi(t) (i=1 to 4) output from the transmitter and receivers 12-i and an output signal “y” of the adder 16. The adaptive processor 14 executes the position parameter detecting routine 200 prepared in a memory 19. Measurement data necessary to detect the position parameters is temporarily held in a data area 19B.

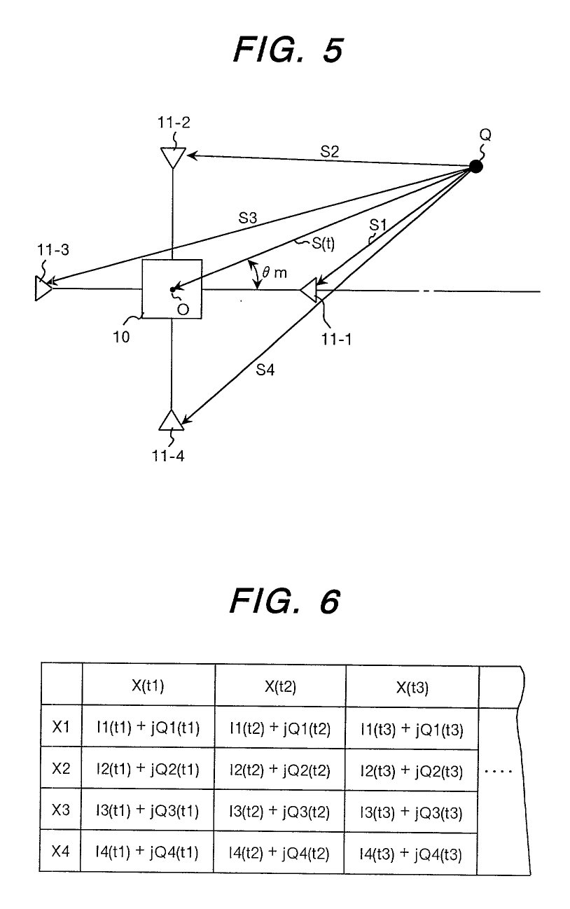

The antenna elements 11-1 to 11-4 are arranged, for example as shown in FIG. 5, on the X and Y axes having an origin O of the base station as a center, and receive radio waves of different phases from a mobile station indicated by a point Q. S1 to S4 denote input signals to the antenna elements. Received signals xi (i=1 to 4) are output from the transmitter and receivers 12-i according to the input signals S1 to S4.

The adaptive processor 14 detects an average received power P of the input signal S (hereinbelow, called target radio wave) at the origin O of the base station and an arrival angle θm of the target radio wave S on the basis of the received signals xi output from each of the transmitter and receivers 12-i in a state where the weights wi of the weight adjusting units 13-i are optimized with respect to the target radio wave. These values are notified as position parameters to the MS position administrating station 30 via the controller 17.

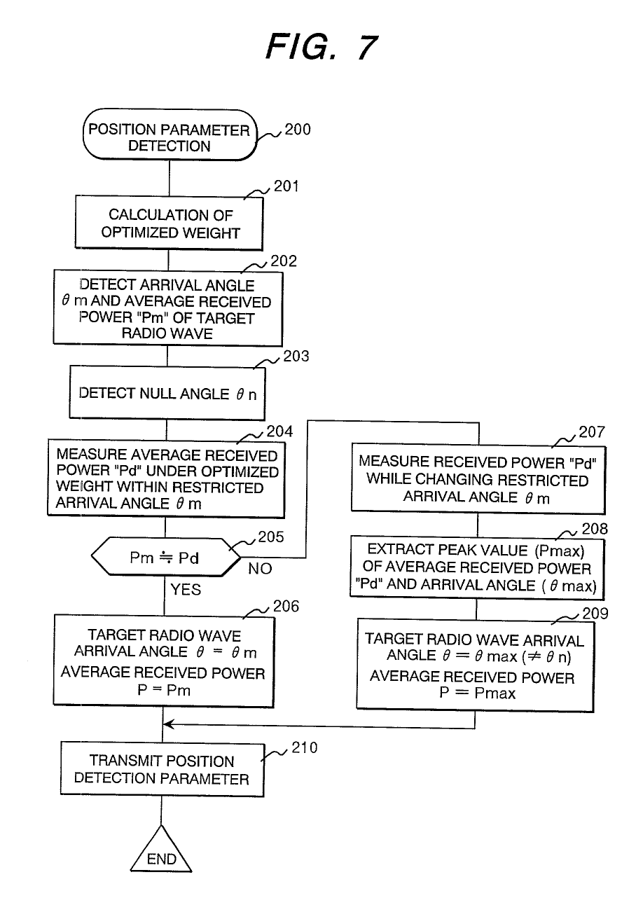

The operation of the adaptive processor 14 will be described in detail hereinbelow with reference to the configuration diagram of the base station of FIG. 4 and the flowchart of the position parameter detecting routine 200 of FIG. 7.

The input signal S1 from the antenna element 11-1 is amplified by the transmitter and receiver 12-1 and frequency-converted into an in-phase signal I and a quadrature signal Q which are input to the weight adjusting unit 13-1. In the following description, an in-phase signal I(t) and a quadrature signal Q(t) input to the weight adjusting unit 13-1 at time t will be expressed generically as an input signal x1(t). Similarly, input signals to the weight adjusting units 13-2, 13-3, and 13-4 will be expressed as x2 (t),x3 (t) and x4(t), respectively.

Each of the weight adjusting units 13-i performs phase adjustment and amplitude adjustment on each of the received signals I and Q in accordance with a weight adjustment value designated by the adaptive processor 14. The adjustment values for the signals I and Q in the weight adjusting unit 13-i will be generically expressed as wi(t). Signals y1(t) to y4(t) subjected to the phase and amplitude adjustment in the weight adjusting units 13-1 to 13-4 are added by the adder 16, and the resultant is supplied as a signal y(t) to the controller 17 and the adaptive processor 14.

The adaptive processor 14 controls the weight value wi(t) and detects the arrival angle θm of the target radio wave s(t) and the average received power P on the basis of the output signals xi(t) from each of the transmitter and receivers 12-i, a reference signal r(t) output from the reference signal generator 15 as a replica of the target radio wave, and the output signal y(t) from the adder 16.

When an instruction of detecting the position parameters is given from the MS position administrating station 30 to the adaptive processor 14, to extract the target radio wave s(t) from the input signals x1(t) to x4(t), first, the adaptive processor 14 calculates optimized weight of each of the weight adjusting units 13-i (step 201) and the average received power P of the position detection signals and the arrival angle θ are detected in a state where the optimized weight is given to each of the weight adjusting units 13-1 to 13-4 (step 202).

As optimized weight calculating methods in the case where the arrival angle θ of the target radio wave s(t) is unknown, CMA (Constant Modulus Algorithm), MMSE (Method of Minimum Squared Error), and the like are known. Calculation of the optimized weight in the case of adopting the MMSE as a main stream in the current mobile communication will be described here. In the MMSE, the optimized weight is determined by minimizing the difference between the output signal y(t) and the reference signal r(t) as a replica of the target radio wave s(t).

At the time of detecting the position of a mobile station, the mobile station transmits, as a position detection signal, a signal having the same pattern as the reference signal r(t). In the case of setting the value of the input signal xi at time t1 as xi=Ii(t)+jQi(t) and storing the values of the input signals x1, x2, x3, and x4 at time t1, t2, t3, . . . in a matrix having the time base in the row direction as shown in FIG. 6, an input signal from each of the transmitters and receivers 12-i at time t, weight value, and output signal of the adder 16 are expressed as the following equations (1), (2), and (3), respectively.

X(t)=[x1(t),x2(t),x3(t),x4(t)]^{T} (1)

W=[w1,w2,w3,w4]^{T} (2)

y(t)=[x1(t)w1(t),x2(t)w2(t),x3(t)w3(t),x4(t)w4(t)]^{T} (3)

T in the equation (1) denotes transpose, specifically, which means that the positions of the row and column in the matrix are altered. T in the equations (2) and (3) has the same meaning.

In the matrix shown in FIG. 6, after a correlation matrix Rxx of an input signal X(t) is obtained by the following equation (4) and a correlation vector rₓᵣ between the input signal X(t) and the reference signal r(t) is computed by the following equation (5), an optimized value Wmmse of the weight W can be obtained from the following equation (6).

$$\begin{matrix}Rxx = \frac{1}{M} {\sum }_{t = 1}^{M} X ( t ) {X ( t )}^{H} & ( 4 ) \\ {r}_{xr} = \frac{1}{M} {\sum }_{t = 1}^{M} X ( t ) {r ( t )}^{*} & ( 5 )\end{matrix}$$

Wmmse=Rxx⁻¹rₓᵣ (6)

where, the numerical subscript “*” in the equation 5 denotes a complex conjugate, that is, it means inversion of the sign of the imaginary quantity part of the complex number. The numerical subscript H in the equation (4) denotes transpose of a complex conjugate and M indicates the number of samples of the input signal X(t)

In the case of making the mobile station transmit the position detection signal having the same pattern as that of the reference signal r(t) and giving the optimized weight Mmmse expressed by the equation (6) to each of the weight adjusting units 13-i, an average power P of the output signal y(t) (hereinbelow, called average received power) becomes equal to the averaged power of the target radio wave s(t).

y(t)=r(t)=s(t) (7)

In the case of using the target radio wave s(t) having the arrival angle θm as a reference, setting reception phase terms of received signals in the elements 11-1 to 11-4 of the adaptive antennas as v1 (θ) v2(θ), v3(θ), and v4(θ), respectively, and a direction vector V(θm) of the reception phase term by the following equation (8), the correlation vector rₓᵣ expressed by the equation (5) can be expressed as the following equation (9).

V(θ)=[v1(θ),v2(θ),v3(θ),v4(θ)]^{T} (8)

$${r}_{xr} = ( \frac{1}{M} {\sum }_{t = 1}^{M} s ( t ) {r ( t )}^{*} ) V ( θ m ) = Pm \cdot V ( θ m ) \qquad ( 9 )$$

Therefore, by obtaining the correlation vector rₓᵣ of the input signal vector X(t) and the reference signal r(t) by using the matrix of input signals shown in FIG. 6 and measuring the averaged power Pm of the output signal y(t), the arrival angle θm of the target radio wave can be detected from the relations of the equations (5) and (9).

There is a characteristic such that when the optimized weight is derived by the MMSE, a directivity pattern of an antenna creates null (zero point) in the arrival direction of an interference wave. A response value D of the adaptive array is expressed by the following equation (10). Therefore, in the embodiment, the directivity pattern of the antenna is computed by changing θ in the optimized weight state, and a null angle θn indicative of the arrival direction of the interference wave is detected from the directivity pattern (step 203).

D=Wmmse^{H}.V(θ) (10)

In the case where an interference wave having high correlation with the target radio wave arrives during reception of the target radio wave from a mobile station, the arrival angle θm of the target radio wave detected by the MMSE indicates an arrival angle of a pseudo radio wave generated by combining the target radio wave and the interference wave, which is different from the actual arrival angle of the target radio wave.

In this case, it is necessary to increase the detection accuracy of the arrival angle of the target wave by eliminating the influence of the interference wave. The influence of the interface wave can be eliminated by employing an adaptive algorithm of a DCMP (Directionally Constrained Minimization of Power) method for computing optimized weight for an input signal at a specific arrival angle or an MSN (Maximum Signal to Noise ratio) method.

The subsequent operation of the adaptive processor 14 in the case of employing the DCMP will be described. The DCMP is a method of minimizing the influence of a radio wave arriving from directions other than the main lobe direction of the antenna, and an optimized weight Wdcmp is expressed by the following equation (11). θ in the equation (11) is called a restricted arrival angle.

Wdcmp=Rxx⁻¹V(θ)(V^{H}(θ)Rxx⁻¹V(θ))⁻¹ (1)

The adaptive processor 14 measures the average received power Pd in a state where the weight Wdcmp obtained by substituting the value of θm extracted by the MMSE for the restricted arrival angle θ in the equation (11) is applied to the weight adjusting units 13-1 to 13-4 (step 204). After that, the average received power Pd and the average received power Pm measured by the MMSE are compared with each other (step 205).

When the average received powers Pd and Pm are almost equal to each other, it is assumed that there is no influence of the interference wave and the arrival angle θm extracted by the MMSE indicates the direction of a reception signal from the mobile station. In this case, θm is used as the value of the parameter θ indicative of the arrival angle of the target radio wave and the value Pm is used as the value of the parameter P indicative of the averaged received power of the target radio wave (step 206), and those position parameters are transmitted to the MS position administrating station 30 via the controller 17 (step 210).

When the average received powers Pd and Pm are obviously different from each other, it is assumed that there is an influence of an interference wave having correlation with the target radio wave, and the average received power Pd is measured again. In this case, by changing the value θ, different weights Wdcmp are calculated one after another from the equation (11) and the average received power Pd is measured while changing the weight applied to the weight adjusting unit, thereby to record the correspondence relation between the restricted arrival angle θ and the average received power Pd (step 207). As a result, it is detected that the average received powers Pd indicate peak values at some restricted arrival angles θ.

Out of the restricted arrival angles θ at which the average received power Pd becomes a peak value, an angle corresponding to the null angle described in the equation (1) is eliminated, and the maximum peak value and an arrival angle corresponding thereto are extracted as the average received power Pmax and the restricted arrival angle θmax (step 208). In this case, the restricted arrival angle θmax is employed as the value of the parameter θ indicative of the arrival angle of the target radio wave and the value of Pmax is employed as the value of the parameter P indicative of the average received power of the target radio wave (step 209). These position parameters are transmitted to the controller 17 (step 210).

By combining a plurality of algorithms in the adaptive array like the above-described MMSE and DCMP, the arrival angle θm of the target radio wave and the average received power P can be detected with accuracy.

The MS position administrating station 30 detects the position of the mobile station on the basis of the position parameters reported from the base station 10, and the map information and structure information prestored in the map data file 35. The position of the mobile station is estimated by executing a position detecting routine 300, which will be described hereinlater, by the processor 31.

In the MS position administrating station 30, the structures existing between the base station and the mobile station are preliminarily modeled, and for example, by applying a ray-trace method or the like, a propagation path of the target radio wave and the position of the mobile station are estimated in consideration of reflection and diffraction of the radio wave at road surfaces and obstacles.

In this case, due to an error which occurs at the time of calculating a loss of reflection and diffraction, an error occurs in the propagation distance of the radio wave transmitted from the mobile station. Consequently, the mobile station is notified of the present position on assumption that the present position is located within an error range around the estimated position as a center. The error of the propagation distance varies depending on the accuracy of modeling of the structures.

A method of detecting the position of the mobile station by the MS position administrating station 30 will be described hereinbelow.

When the mobile station 1 is visible from the base station 10, the propagation path of the position detection signal (target radio wave S) may be approximated by a model, in which only one reflection wave from the earth exists. In this case, the relations between the average received power P at the base station 10 and the propagation distance “d” are expressed by the equations (12) and (13). From these equations, the propagation distance d of the position detection signal can be calculated in accordance with the average received power P.

P=−20log(4πd/λ)+20log(1+Γ)+Pt(d<2πh_{b}hₘ/λ) (12)

P=−20log(d²/h_{b}hₘ)+Pt(d>2πh_{b}hₘ/λ) (13)

where Pt denotes an output power (fixed value) of the position detection signal from the mobile station, h_{b} denotes the height of the mobile station, hₘ indicates the height of the antenna of the base station, and Γ indicates a reflection coefficient.

In the case of TE incidence in which the position detection signal propagates as a vertical vibration wave, the reflection coefficient Γ is expressed by Γ_{H} of the equation (14). In the case of TM incidence in which the position detection signal propagates as a horizontal vibration wave, the reflection coefficient Γ is expressed by Γᵥ of the equation (15). φ indicates an incidence angle to the ground surface, and ε_{c} denotes a complex dielectric constant.

$$\begin{matrix}{Γ}_{H} = \frac{cos φ - \sqrt{{ϵ}_{c} - {sin}^{2} φ}}{cos φ + \sqrt{{ϵ}_{c} - {sin}^{2} φ}} & ( 14 ) \\ {Γ}_{V} = \frac{{ϵ}_{c} cos φ - \sqrt{{ϵ}_{c} - {sin}^{2} φ}}{{ϵ}_{c} cos φ + \sqrt{{ϵ}_{c} - {sin}^{2} φ}} & ( 15 )\end{matrix}$$

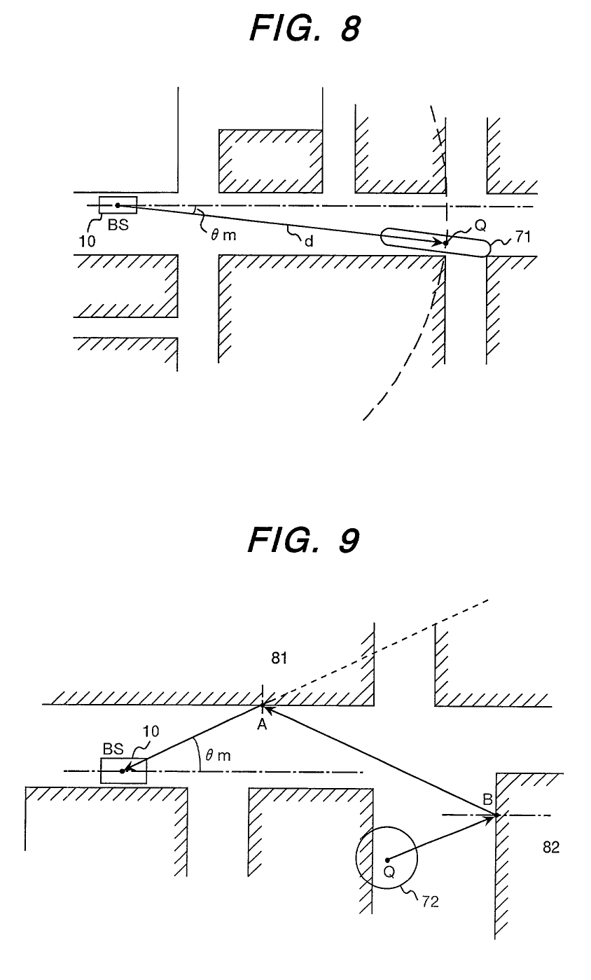

FIG. 8 shows an example of a position detection result in the case where a mobile station is visible from a base station.

For example, when a position detection signal (target radio wave) is detected as the arrival angle θm of minus two degrees and the average received power P of −70 dBm by the base station for PHS, the position of the mobile station 1 estimated by the MS position administrating station 30 is as follows.

When it is now assumed that the ground around the base station is made of concrete, the output power Pt of the mobile station is 10 mW, the output wavelength λ is 15 cm, the height h_{b} of the mobile station is 1.5 m, and the height hₘ of the antenna of the base station is 10 m, the estimated distance (propagation distance of the radio wave) “d” between the mobile station and the base station is derived as 200 m from the equations (12) and (15). Therefore, the current position of the mobile station is estimated as the position Q of 200 m away from the base station 10 in the direction of the arrival angle θm of −2 degrees.

Since there is an error between the reflection coefficient of the ground when the average received power P is actually measured by the base station and the reflection coefficient Γ employed in the formula 12, the estimated distance “d” of 200 m includes an error due to the difference in the reflection coefficient Γ. When the error amount is assumed to be 1 dB, the error in the propagation distance is about 25 m. Consequently, the current position of the mobile station is determined as a range 71 of the distance 25 m from the estimated position Q.

Whether the mobile station is in a location visible from the base station or not can be determined by estimating the distance “d” by the formulae (12) to (14) and overlapping the estimated position Q of the mobile station onto the map of the area including the base station. As shown in FIG. 8, when there is no obstacle between the estimated position Q and the base station, the position information indicative of the range 71 is notified to the mobile station via the base station.

When an obstacle (structure) exists between the estimated position Q and the base station, by using the ray-trace method, for example, the propagation characteristics including reflection are analyzed. Calculation of the position of the mobile station in the case where the mobile station 1 is blind from the base station 10 will be described hereinbelow.

In analysis of the propagation characteristics including the reflection, the reflection coefficient Γ of an obstacle has to be computed. In the case of a PHS of the TM incidence, since it is assumed that the wall faceof a building is sufficiently larger than the wavelength λ, the equation (15) can be applied.

FIG. 9 shows an example of a result of position detection in the case where the mobile station is blind from the base station.

For example, when the target radio wave is detected as the arrival angle θm of 30 degrees and the average received power P of −80 dBm by the base station 10 of the PHS, the position of the mobile station 1 detected by the MS position administrating station 30 is as follows. It is also assumed that the ground around the base station is made of concrete, the output power Pt of the mobile station is 10 mW, the output wavelength λ is 15 cm, the height h_{b} of the mobile station is 1.5 m, and the height hₘ of the antenna of the base station is 10 m.

In the case of the example, since the average received power is attenuated more than that in the example of FIG. 8, the estimated distance d calculated first is 200 m or longer. When the position of the estimated distance d is overlapped on the map of the area including the base station 10 in the direction of the arrival angle θm of 30 degrees, it is found that the radio wave is reflected by a structure 81 at the point A. By tracing the propagation path in the incident direction at the point A, it is found that the radio wave is reflected by a structure 82 at the point B.

When it is assumed that the reflection points A and B are on the concrete wall surface, at the point A, the radio wave is reflected in such a manner that the incident angle is 60 degrees, the reflection coefficient is 0.5, and a reflection loss is 6 dB. Similarly, at the point B, the radio wave is reflected in such a manner that the incident angle is 30 degrees, the reflection coefficient is 0.66, and the reflection loss of 3.6 dB.

The propagation distance d is calculated as 210 m by the equation (12) in consideration of the reflection losses. However, since there is an error between the reflection coefficient on the building when the average received power P is actually measured by the base station and the reflection coefficient Γ of the modeled structure employed in the formula 12, the estimated distance d of 210 m includes an error due to difference in the reflection coefficient Γ. When the error is assumed as 3 dB, an error in distance is about 80 m.

In this case, the position of the mobile station is determined as an area 72 having an error range of 80 m with respect to, as a center, the estimated position Q apart from the base station 10 by 210 m on the propagation path of the position detection signal (target radio wave) including the reflection points A and B.

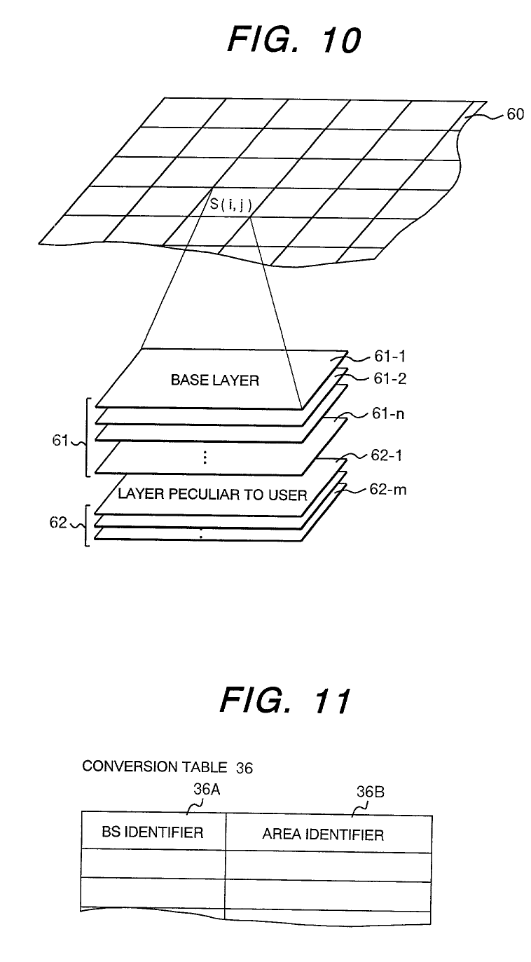

FIG. 10 shows the structure of the map data stored in the map data file 35.

A map 60 is comprised of a plurality of mesh areas. Map information of base layers 61 and information of layers 62 peculiar to the user are prepared in correspondence with the mesh areas.

The base layer 61 is prepared to define information necessary to draw a general map and comprises of, for example, a plurality of layers 61-1 to 61-n classified into components such as roads, blocks, boundaries of cities, wards, towns and villages, railroads, rivers, and houses, and names and symbols of the components of the map.

On the other hand, the layer 62 peculiar to the user indicates information individually prepared by the user. In the case of the invention, the position of each base station, the height of the antenna of the base station, the height of each structure located on the map around the base station, reflection coefficient of a wall surface, reflection coefficient data of roads and open spaces, and the like are prepared as layers 62-1 to 62-m peculiar to the user.

FIG. 11 shows the configuration of the conversion table 0.36 to which the processor 31 of the MS position administrating station 30 refers.

The conversion table 36 defines the corresponding relation between a base station identifier 36A and a mesh area identifier 36B in the map where the base station is located. When the position parameter is received from the base station, the conversion table 36 is referred to read out map information in the mesh area corresponding to the identifier of the base station as a transmission source from the map data file 35.

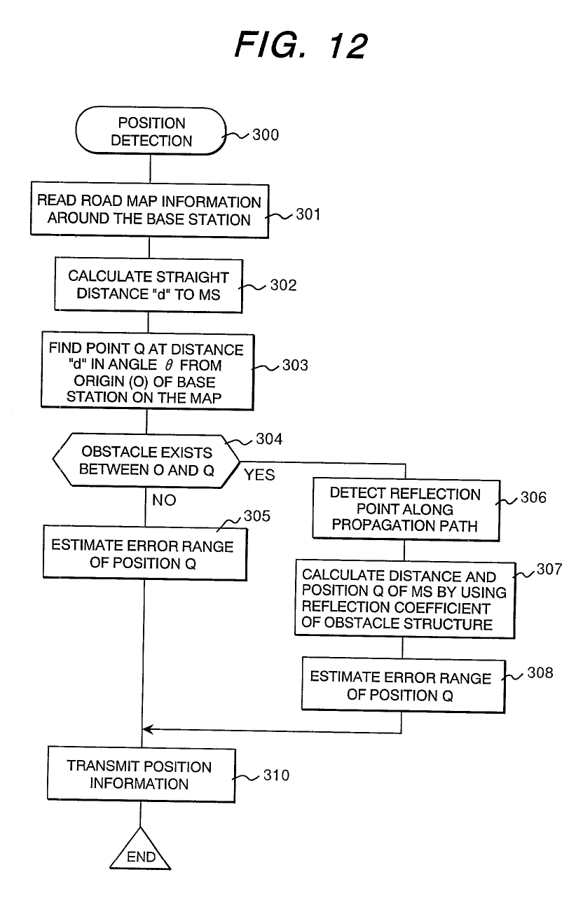

FIG. 12 shows a flowchart of a position detecting routine 300 executed by the processor 31 of the MS position administrating station 30.

In the position detecting routine 300, by referring to the conversion table 36 on the basis of the identifier of the base station 10-j as a transmission source of the position parameter, the identifier 36B of the mesh area in which the base station 10-j is located is specified, and the road map information corresponding to the identifier 36B of the mesh area is read out from the map data file 35 (step 301).

According to the above-described equations (12) to (15), the straight distance d from the base station 10-j to the mobile station is calculated (step 302), and the point Q on the straight distance d extended from the base station as an origin at the arrival angle θm on the road map is specified (step 303). The information of the layer indicative of a house shape or structure in the mesh area is read out from the map data file 35 and the presence or absence of an obstacle on the straight line connecting the base station and the point Q is determined (step 304).

If no obstacle exists between the base station and the point Q, the error range of the point Q is calculated (step 305), and the present position of the mobile station is notified to the base station 10-j (step 310).

If an obstacle exists between the base station and the point Q, the propagation path of the radio wave is traced from the base station 10-j as an origin, and the structure as a reflection point on the propagation path of the distance d is specified (step 306). The reflection coefficient of the structure as the reflection point is read out from the map data file 35, a new propagation distance d along the reflection path is calculated, and the position Q of the mobile station is specified (step 307). After that, the error range of the position Q of the mobile station is calculated (step 308), and the present position of the mobile station is notified to the base station 10-j (step 310).

As described above, according to the invention, after calculating the straight distance from the base station to the mobile station on the basis of the position parameters detected by the base station, the presence or absence of an obstacle is determined from the map information. When an obstacle exists, the preliminarily modeled structure information is referred to, the propagation path and propagation distance are calculated in consideration of attenuation by reflection of a target radio wave, and the position of the mobile station is estimated.

Therefore, according to the invention, the present position of a mobile station can be localized within the coverage of each base station. At the time of an actual operation, by indicating an error range which occurs on assumption of the propagation distance in the position information to be notified to the mobile station, erroneous position information can be prevented from being presented to the terminal user.

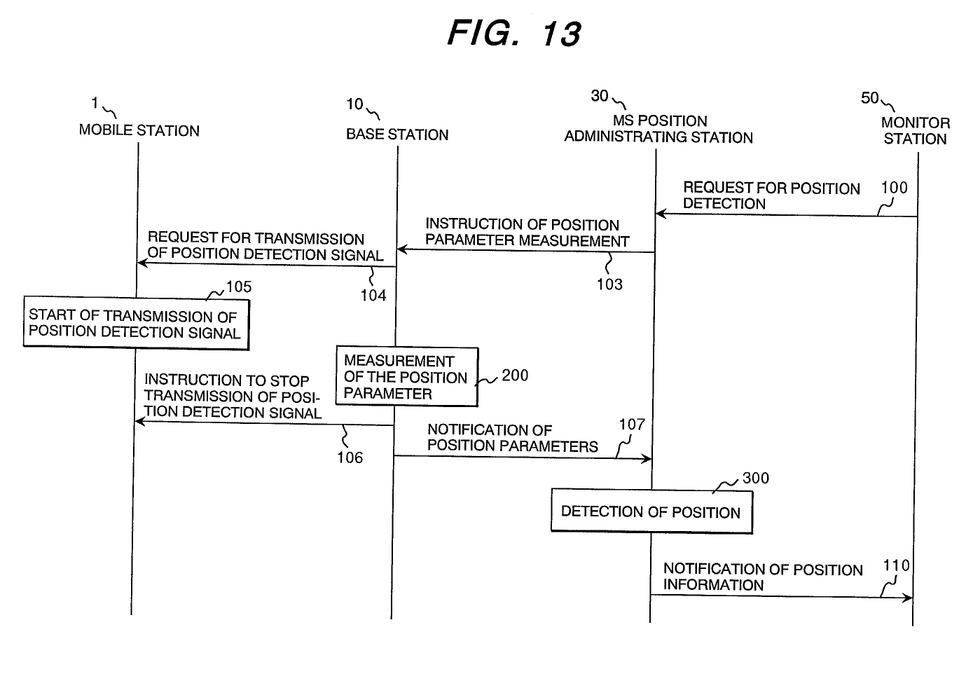

FIG. 13 shows a control sequence used in the case where the monitor station 50 illustrated in FIG. 1 sends a request to detect the position of a specific mobile station.

When the identifier of a mobile station to be detected is designated and the position detection request is transmitted from the monitor station 50 to the MS position administrating station 30 (step 100) the MS position administrating station 30 instructs the base station 10 having the mobile station within its coverage to measure the position parameter (step 102). The base station requests the mobile station designated by the position parameter measurement instruction to transmit a position detection signal (step 104). Subsequently, the process 300 of detecting the position of the mobile station is executed by a sequence (steps 105 to 107) similar to that in FIG. 3, and the position detection result is transmitted from the MS position administrating station 30 to the monitor station as a request source (step 110).

In the foregoing embodiment, the base station 10 measures the arrival angle θ of the target radio wave and the average received power P as the position parameters, and the MS position administrating station 30 calculates the propagation distanced of the received radio wave in consideration of the wave attenuation amount at each of the reflection points on the propagation path of the received wave determined from the map information.

In the invention, however, it is also possible to calculate the propagation distance d of the received radio wave from the mobile station by using a relational expression of propagation velocity Vc of the radio wave and propagation time ΔT by each of the base stations 10 and transmit the propagation distance d together with the arrival angle θ of the target radio wave to the MS position administrating station 30.

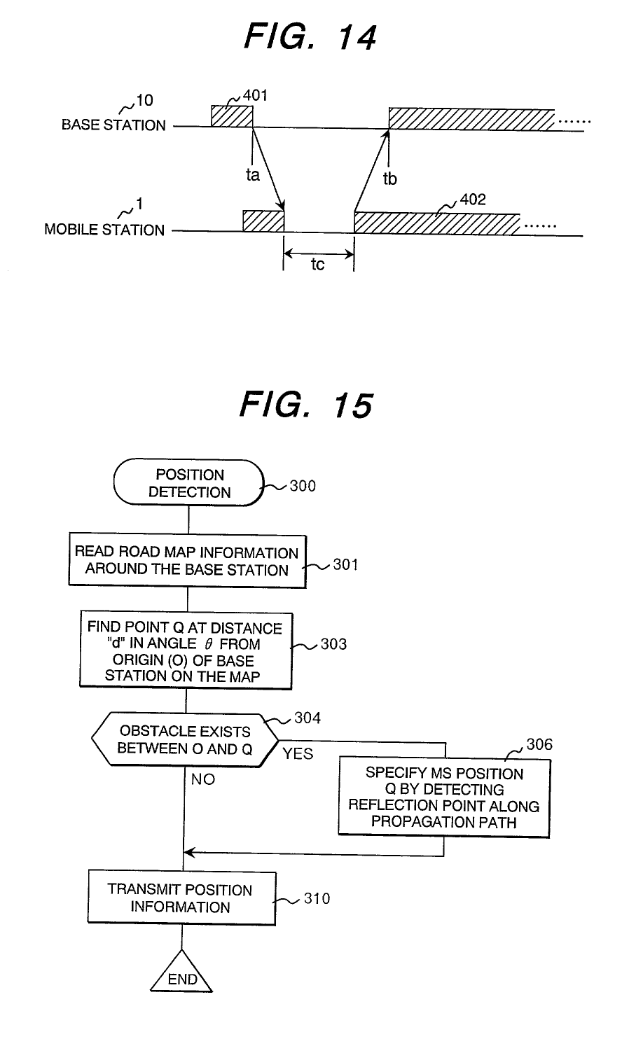

FIG. 14 shows a method of measuring the wave propagation distance “d” by the base station 10.

For example, in the case of transmitting a transmission request of the position detection signal from the base station 10 to the mobile station 1 in step 104 in FIG. 3, as shown in FIG. 14, the base station 10 records the time “ta” of completion of transmission of a request message 401 and waits for arrival of a position detection signal 402 from the mobile station 1. The mobile station 1 is allowed to start transmitting the position detection signal 402 after elapse of predetermined time “tc” since the request message 401 is received. When the reception time of the position detection signal 402 by the base station is “tb”, propagation required time ΔT of the radio wave from the base station to the mobile station is calculated as (tb−ta−tc)/2, so that the distanced from the base station to the mobile station can be calculated by the equation of d=Vc×ΔT.

The measurement of the propagation required time AT of the radio wave and calculation of the radio wave propagation distance d may be performed, for example, in the position parameter detecting routine 200 shown in FIG. 7 prior to the optimized weight calculating step 201. In the case of the embodiment, the average received power P of the target radio wave is unnecessary for the calculation of the position of the mobile station. Consequently, in the final step 210 of the routine 200, it is sufficient to transmit, as position parameters, the arrival angle θ of the target radio wave and the value of the wave propagation distance “d” to the MS position administrating station 30.

FIG. 15 shows a flowchart of a position detecting routine 300S executed by the MS position administrating station 30 in the case where the wave propagation distance d is calculated by the base station.

When the wave propagation distance d calculated from the propagation time ΔT of the signal wave is used as in the embodiment, it becomes unnecessary to consider the calculation error of the distance caused by the reflection coefficient error. Consequently, from the routine 300 shown in FIG. 12, in addition to the straight distance calculating step 302, steps 305, 307, and 308 of calculation of the error range and the wave propagation distance in consideration of the reflection coefficient can be omitted. When there is an obstacle between the base station and the mobile station, in step 306, while specifying the reflection point on the map, it is sufficient to specify the point of the wave propagation distance d from the base station 10 in the direction according to the rule of reflection of waves. According to the embodiment, the position of a mobile station can be estimated with higher precision as compared with the embodiments described in FIGS. 7 and 12.

Although the position parameters are detected by the base station 10 and the position of the mobile station is detected by the MS position administrating station 30 in the foregoing embodiment, as a modification of the invention, the function of detecting the position of a mobile station may be given to each of the base stations and the base station 10 may individually respond to a position detection request from a mobile station. In this case, it is sufficient to provide the controller 17 of the base station with the function of detecting the position of a mobile station (execution of the position detecting routines 300 and 300S), and to allow the controller 17 to detect the position of the station by using the map data file 35 and conversion table 36.

In the case where the detection of the position parameters and the position detection are performed by each of the base stations 10, the steps 102, 103, 107, and 108 in the control sequence of FIG. 3 can be omitted. Thus, a position retrieval request from a mobile station can be promptly responded.

Although the base station 10 detects the position parameters by the combination of MMSE and DCMP in the embodiment, it is obvious that adaptive algorithms other than the algorithm described in the embodiment can be also applied.

As obviously understood from the above description, according to the invention, parameters necessary to detect the position of a mobile station are detected by a base station having an adaptive array antenna and the present position of the mobile station is estimated on the basis of the position parameters, map information. Thus, the position of a mobile station within the coverage of a base station can be localized in a relatively narrow range.

What is claimed is:

1. A method of detecting the position of a mobile station by using abase station for mobile communication having an adaptive array antenna comprising a plurality of antenna elements, comprising:
a step of detecting position detection parameters including an arrival angle and an average received power of a position detection signal from the mobile station by a base station which receives the position detection signal; and
a step of calculating the position of the mobile station on the basis of said position detection parameters and map information of an area including said base station by the base station or any of stations constructing a mobile communication system.

2. The method of detecting the position of a mobile station according to claim 1, wherein the step of detecting the position detection parameters comprises:
a first step of detecting position detection parameters by a first adaptive algorithm for optimizing weight to be given to a received signal from each of the antenna elements with respect to said position detection signal;
a second step of measuring an average received power by a second adaptive algorithm for optimizing weight to be given to a received signal from each of the antenna elements with respect to a received signal from a specific arrival angle direction detected by said first step; and
a third step of verifying said position detection parameters by comparing the average received power measured in said first step with the average received power measured in said second step.

3. The method of detecting the position of a mobile station according to claim 2, wherein the step of detecting the position detection parameters includes a fourth step of repeating, when said position detection parameters are determined as inappropriate in said third step, measurement of the average received power while changing an arrival angle to be optimized in accordance with said second adaptive algorithm, detecting an average received power and an arrival angle as peak values, and setting the detected values as new position detection parameters.

4. The method of detecting the position of a mobile station according to claim 3, wherein the step of detecting the position detection parameters includes a step of detecting an arrival angle of an interference wave in a state where weight to be given to a received signal from each of the antenna elements is optimized by said first adaptive algorithm, and
said new position detection parameters are detected by eliminating the arrival angle of said interface wave in said fourth step.

5. The method of detecting the position of a mobile station according to claim 1, wherein said position calculating step comprises:
a step of calculating a straight distance from said base station to said mobile station on the basis of an average received power indicated in the position detection parameters and a preliminarily given propagation distance characteristic;
a step of determining the presence or absence of an obstacle existing between said base station and said mobile station on the basis of map information of an area including said base station; and
a step of specifying the position of the mobile station on the map on the basis of the position of said base station, the arrival direction indicated in the position detection parameters, and said straight distance in the case where it is determined that there is no obstacle between said base station and the mobile station.

6. The method of detecting the position of a mobile station according to claim 5, further comprising a step of specifying, when it is determined that there is an obstacle between said base station and the mobile station, reflection points of said position detection signal and a propagation path on the basis of said map information, calculating a propagation distance by applying a reflection coefficient of each of the reflection points which are preliminarily modeled, and specifying the position of the mobile station on the map.

7. The method of detecting the position of a mobile station according to claim 5, further comprising a step of setting an error range by using the position of the mobile station specified in said position calculating step as a center.

8. A method of detecting the position of a mobile station by using abase station for mobile communication having an adaptive array antenna comprising a plurality of antenna elements, comprising:
a step of detecting position detection parameters including an arrival angle and a propagation distance of a position detection signal from a mobile station by abase station which receives the position detection signal; and
a step of calculating the position of said mobile station on the basis of said position detection parameters and map information of an area including said base station by the base station or any of stations constructing a mobile communication system.

9. The method of detecting the position of a mobile station according to claim 8, wherein the step of detecting said position detection parameters comprises:
a first step of detecting a propagation distance of the position detection signal from propagation required time of said position detection signal;
a second step of detecting an arrival angle and an average received power of the position detection signal by a first adaptive algorithm for optimizing weight to be given to a received signal from each of the antenna elements with respect to said position detection signal;
a third step of measuring an average received power by a second adaptive algorithm for optimizing weight to be given to a received signal from each of the antenna elements with respect to the received signal from the specific arrival angle direction detected in said second step; and
a fourth step of verifying said arrival angle by comparing the average received power measured in said second step with the average received power measured in said third step.

10. The method of detecting the position of a mobile station according to claim 9, wherein the step of detecting said position detection parameters includes a fifth step of repeating, when it is determined in said fourth step that said arrival angle is inappropriate, measurement of the average received power while changing an arrival angle to be optimized in accordance with said second adaptive algorithm, detecting an average received power and an arrival angle as peak values, and setting the detected arrival angle and radio wave propagation distance as new position detection parameters.

11. The method of detecting the position of a mobile station according to claim 10, wherein the step of detecting said position detection parameters includes a step of detecting an arrival angle of an interference wave in a state where weight to be given to a received signal from each of the antenna elements is optimized by said first adaptive algorithm, and
said new position detection parameters are detected by eliminating the arrival angle of said interface wave in said fifth step.

12. The method of detecting the position of a mobile station according to claim 8, wherein said position calculating step comprises:
a step of determining the presence or absence of an obstacle existing between said base station and said mobile station on the basis of map information of an area including said base station; and
a step of specifying, when it is determined that there is no obstacle between said base station and the mobile station, the position of the mobile station on the map on the basis of the position of said base station, said arrival direction of the radio wave and said propagation distance indicated in said position detection parameters.

13. The method of detecting the position of a mobile station according to claim 12, further comprising a step of specifying, when it is determined that there is an obstacle between said base station and the mobile station, reflection points of said position detection signal and a propagation path in accordance with said map information, and specifying the position of the mobile station on the map.

14. A base station for mobile communication comprising:
a plurality of antenna elements;
a plurality of weight adjusting units corresponding to said antenna elements; and
an adaptive processor for controlling a weight value to be set in each of the weight adjusting units,
wherein said adaptive processor has means for detecting an arrival angle of a position detection signal transmitted from a mobile station and an average received power or propagation distance of said position detection signal, and outputting the detected values as position detection parameters.

15. The base station according to claim 14, wherein said adaptive processor has means for verifying said position detection parameters by comparing the average received power detected by a first adaptive algorithm for optimizing a weight value with respect to a position detection signal transmitted from the mobile terminal with an average received power detected by a second adaptive algorithm for optimizing a weight value with respect to a received signal from a specific arrival angle direction detected by said first adaptive algorithm.

16. A mobile communication system comprising a plurality of base stations and a position administrating station connected to each of said base stations via a communication network,
wherein at least one of said base stations has means for detecting an arrival angle of a position detection signal transmitted from a mobile station and an average received power or propagation distance of said position detection signal, and transmitting the detected values as position detection parameters to said position administrating station, and
said position administrating station is provided with means for detecting the position of the mobile station on the basis of the position detection parameters received from the base station and the map information of the area including the base station.

17. The mobile communication system according to claim 16, wherein said position detecting means calculates a straight distance from said base station to said mobile station on the basis of an average received power indicated in said position detection parameters and a formula expressing propagation distance characteristic preliminarily given, determines the presence or absence of an obstacle between the base station and the mobile station on the basis of map information of an area including said base station, specifies reflection points and a propagation path of the position detection signal in accordance with said map information when it is determined that there is an obstacle, calculates the propagation distance by using preliminarily modeled reflection coefficients of each of reflection points, and specifies the position of the mobile station on the map.

18. The mobile communication system according to claim 16, wherein said position detecting means determines the presence or absence of an obstacle between the base station and a mobile station on the basis of said position detecting parameters and map information of the area including said base station, specifies a reflection points of said position detection signal and a propagation path on the basis of said map information when it is determined that there is an obstacle, and estimates the position of said propagation distance along the propagation path as the position of the mobile station.
